(19) United States
(12) Patent Application Publication
(10) Pub. No.: US 2007/0041023 A1
(43) Pub. Date: Feb. 22, 2007

(54) Measurement data processing method and apparatus

(75) Inventor: Tatsuhiko Suzuki, Atsugi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/268,453

(22) Filed: Nov. 8, 2005

(30) Foreign Application Priority Data
Aug. 17, 2005 (JP) 2005-236670

(51) Int. Cl. G01B 11/30

(52) U.S. Cl. 356/605

(57) ABSTRACT

An object of this invention is to provide a technique to decrease the systematic error such as the distortion aberration in the non-contact light measurement and to realize the absolute value measurement with high accuracy. A measurement data processing method according to this invention includes: obtaining measured coordinate values that are measurement results for a plurality of specified positions corresponding to nodes located in a grid state in a three-dimensional space, and storing the measured coordinate values with coordinate values of the specified positions into a data storage; and generating data of control points for a tensor-product-type composite hypersurface representing a relationship between the coordinate values of the specified positions and the measured coordinate values by using the coordinate values of the specified positions and the measured coordinate value stored in the data storage, and storing the data of the control points into a control point data storage.

### TECHNICAL FIELD OF THE INVENTION

This invention relates to a non-contact type three-dimensional shape measurement technique.

### BACKGROUND OF THE INVENTION

Non-contact type absolute value measurement has been desired in the measurement of the three-dimensional shape. However, presently, there are a lot of methods for the non-contact type absolute measurement, which cannot obtain enough accuracy. The largest reason is the distortion aberration of the optical lens.

US 2005/0046873 discloses a method to realize the absolute value measurement with high accuracy by adopting a calibration method using a hypersurface in a grating pattern projection method or the like. In this publication, a relationship among light receiving coordinates (x, y), a phase angle Φ obtained by converting light intensity I obtained by the observation at the calibration, and a Z coordinate in an object coordinate system is represented by using the hypersurface S. Then, at the measurement, the Z coordinate value in the object coordinate system is calculated from the phase angle Φ obtained by converting the light intensity I obtained by the observation and the light receiving coordinates (x, y) by referring to the hypersurface S prepared at the calibration. Incidentally, it is necessary to calculate the X and Y coordinates in the object coordinate system. However, the explanation therefor is omitted.

However, the measurement method such as a grating pattern projection method has problems that the error increases when the light intensity increased and the heating value became large, and that the environment light must be shut off. Therefore, in the non-contact type optical measurement by an arbitrary method other than the grating pattern projection method, it is desired that the systematic error such as the distortion aberration of the optical lens is decreased and the absolute value measurement with high accuracy is realized.

### SUMMARY OF THE INVENTION

Therefore, an object of this invention is to provide a technique to decrease the systematic error such as the distortion aberration in the non-contact light measurement and to realize the absolute value measurement with high accuracy.

A measurement data processing method according to this invention comprises: obtaining measured coordinate values that are measurement results for a plurality of specified positions corresponding to nodes located in a grid state in a three-dimensional space, and storing the measured coordinate values with coordinate values of the specified positions into a data storage; and generating data of control points for a tensor-product-type composite hypersurface representing a relationship between the coordinate values of the specified positions and the measured coordinate values by using the coordinate values of the specified positions and the measured coordinate value stored in the data storage, and storing the data of the control points into a control point data storage.

By adopting the aforementioned tensor-product-type composite hypersurface, the absolute value measurement with high accuracy becomes possible. Incidentally, in the aforementioned conventional method, the hypersurface is defined by the light receiving coordinates, phase angle Φ and Z coordinate. Although the utilization of the tensor-product-type composite hypersurface is common, the structure of the tensor product composite hypersurface is different in a point that the tensor-product-type composite hypersurface in the conventional method does not represent any relationship between two coordinate values. Furthermore, because the light receiving coordinates are used, the applicable measurement method is limited to the grating pattern projection method or the like. Therefore, it lacks generality.

In addition, the measurement data processing method according to this invention may further comprise calculating an actual coordinate value from a measured coordinate value of an object to be measured by using the data of the control points for the tensor-product-type composite hypersurface, which are stored in the control point data storage, and storing the calculated actual coordinate value into an actual coordinate value data storage.

Furthermore, in the generation of the data of the control points, the data of the control points for the tensor-product-type composite hypersurface whose variables are the measured coordinates may be generated. Thus, a processing in the calculating is simplified.

A computer numerical control apparatus (also called CNC apparatus) according to this invention comprises: an measuring apparatus that carries out the aforementioned processing; and a controller that controls so as to move a reference object to be measured to the specific position. With this configuration, the calibration can be performed quickly and easily. Incidentally, here, the CNC apparatus means a mechanical apparatus having a numerical control function using a computer and is typified by an NC machine tool.

The measurement data processing method according to this invention is carried out by a program and a computer hardware, and this program is stored in a storage medium or a storage device such as a flexible disk, a CD-ROM, an optical magnetic disk, a semiconductor memory, and a hard disk. Further, the program may be distributed as a digital signal through a network. Incidentally, intermediate processing results are temporarily stored in a storage device such as a main memory.

### BRIEF DESCRIPTION OF THE DRAWINGS

FIG. 1 is a functional block diagram in an embodiment of this invention;

FIG. 2A is a diagram showing a processing flow at the calibration;

FIG. 2B is a schematic diagram showing a processing to obtain measured coordinates;

FIG. 3 is a diagram showing an example of a three-dimensional grid in an object coordinate system;

FIG. 4 is a diagram showing an example of data stored in an obtained data storage;

FIG. 5 is a diagram showing an example of a three-dimensional grid in a measured coordinate system;

FIG. 6 is a diagram showing a processing flow of a control point generation processing;

FIGS. 7A to 7C are diagrams showing examples of data stored in a control point data storage;

FIGS. 8A and 8B are diagrams to explain the control point generation processing in a Bezier curve;

FIG. 9 is a diagram to explain the control point generation processing in a B-Spline curve;

FIG. 10 is a diagram showing a processing flow at the measurement; and

FIG. 11 is a functional block diagram of a computer.

### DETAILED DESCRIPTION OF THE PREFERRED EMBODIMENTS

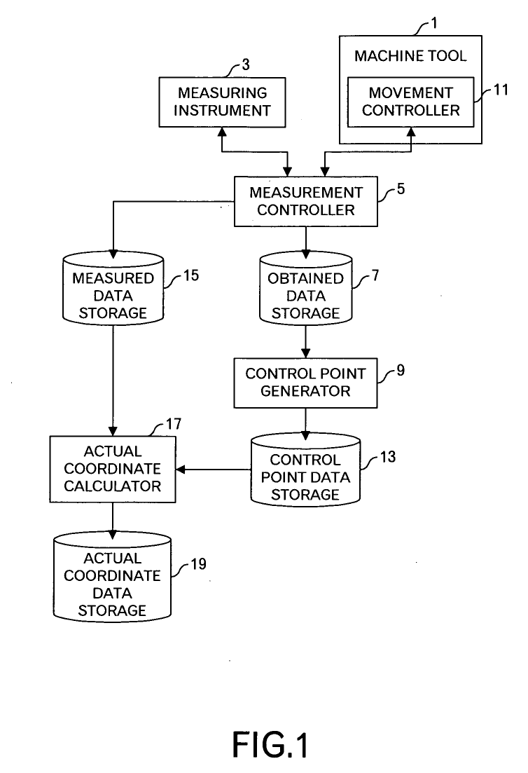

FIG. 1 shows a functional diagram of a CNC apparatus according to an embodiment of this invention. The CNC apparatus according to this embodiment has a machine tool 1 having a movement controller 11 to move an object to be measured, for example, in XYZ directions, a measuring instrument 3 that carries out the non-contact type three-dimensional measurement, a measurement controller 5 that instructs the movement controller 11 to move a reference object to be measured such as a sphere at the calibration and instructs the measuring instrument 3 to carry out the three-dimensional measurement, an obtained data storage 7 to store object coordinates (X, Y, Z) of a feature point of the reference object to be measured and measured coordinates (x, y, z) of the feature point, which are the measurement results by the measuring instrument 3, a control point generator 9 that generates control points for a tensor-product-type composite hypersurface representing the relationship between the object coordinates and the measured coordinates by using data stored in the obtained data storage 7, a control point data storage 13 to store data of the control points generated by the control point generator 9, a measurement data storage 15 to store measurement results that the measuring instrument 3 measures an object to be measured in response to an instruction from the measurement controller 5 at the measurement, an actual coordinate calculator 17 that calibrate the measurement results stored in the measurement data storage 15 by using the tensor-product-type composite hypersurface defined by the data of the control points stored in the control point data storage 13 to calculate actual coordinates of the object to be measured, and an actual coordinate data storage 19 to store data of the actual coordinates of the object to be measured.

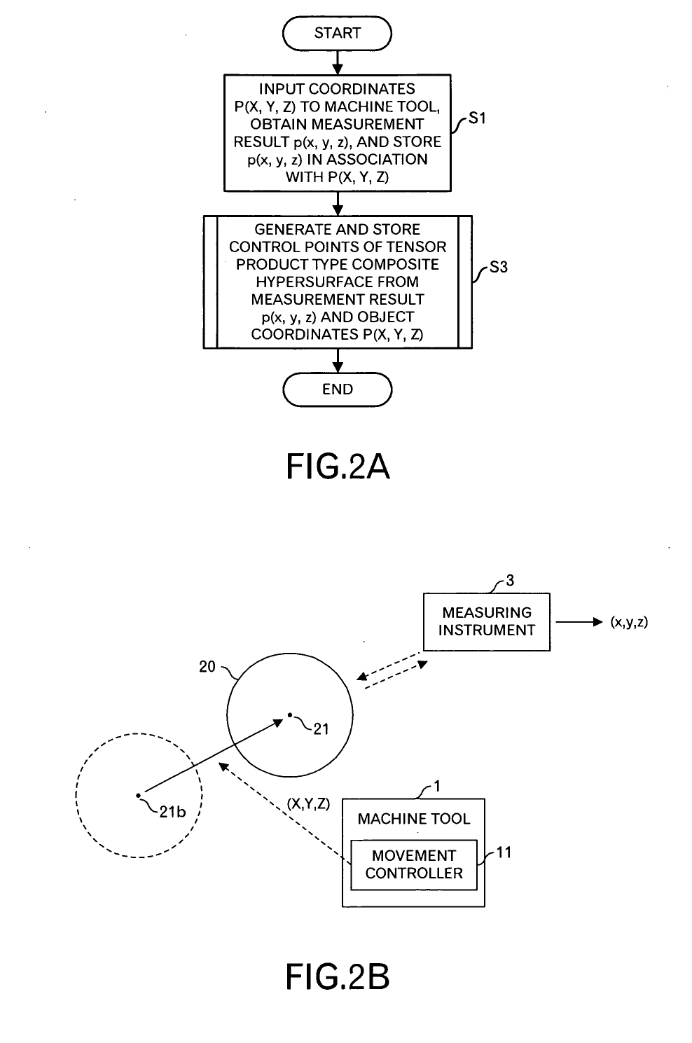

Next, a processing by the CNC apparatus shown in FIG. 1 will be explained using FIGS. 2A to 10.

(1) Processing at the Calibration

First, a data processing at the calibration will be explained using FIGS. 2A to 9. The measurement controller 5 instructs the movement controller 11 of the machine tool 1 to move a feature point (For instance, the center 21 of a sphere 20 in FIG. 2B) of the reference object to be measured (For instance, the sphere 20 in FIG. 2B) to a predetermined object coordinates P(X, Y, Z), instructs the measuring instrument 3 to measure the feature point of the reference object to be measured, and obtains measured coordinates p(x, y, z) that are the measurement results from the measuring instrument 3 to store the measured coordinates p(x, y, z) into the obtained data storage 7 in association with the object coordinates P(X, Y, Z) (step S1). FIG. 2B schematically shows an outline of the step S1. As described above, for example, the sphere 20 is used as the reference object to be measured, and the center 21 of the sphere 20 is used as the feature point. At this time, the movement controller 11 instructs to move the center 21 of the sphere 20 from the point 21b to the coordinates P(X, Y, Z). On the other hand, the measuring instrument 3 carries out the measurement of the sphere 20 after the movement, and outputs the measured coordinate p(x, y, z) of the center 21 of the sphere 20 as the measurement result.

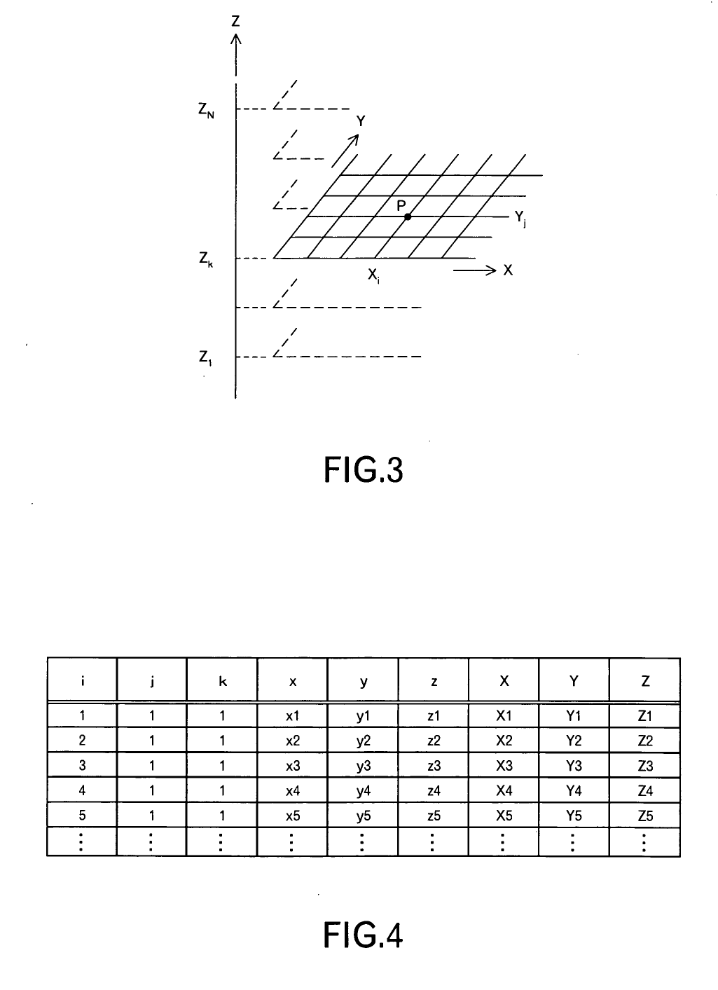

The method to calculate the coordinates of the sphere center from the coordinate values of the sphere surface is well-known. Therefore, the details of the method are not described here. In addition, as for the processing to calculate the coordinates of the sphere center from the coordinate values of the sphere surface, it is possible to carry out by the measurement controller 5 on behalf of the measuring instrument 3. Moreover, as for the reference object to be measured, it is not limited to the sphere, and it may be a cube. Furthermore, the predetermined object coordinates P(X, Y, Z) are coordinates of nodes in the three-dimensional grid as shown in FIG. 3. It is desired that the movement control and acquisition of the measurement data of the feature point by the machine tool 1 are carried out automatically. This is because it contributes to not only the improvement of the efficiency of the calibration but also the decrease of the error in the calibration.

That is, in the three-dimensional object coordinate system, the coordinates of each node in the three-dimensional grid having L nodes in the X axis direction, M nodes in the Y axis direction and N nodes in the Z axis direction, for example, are the predetermined object coordinates P(X, Y, Z). In an example of FIG. 3, nodes are indicated on a plane having a k-th coordinate value Zₖ in the Z axis direction, and the coordinates of a node P in FIG. 3 are (Xᵢ, Yⱼ, Zₖ). In a case where one sphere is used as the reference object to be measured, the sphere is moved to positions of all nodes. Incidentally, the symbol i is used to represent an array in the X axis direction, the symbol j is used to represent an array in the Y axis direction is used, and the symbol k representing an array in the Z axis direction is used. In addition, although FIG. 3 shows a rectangular three-dimensional grid, the grid should be rectangular in phase, and it does not have to be cubic.

Incidentally, a ball array in which a sphere is located in advance at each position of plural nodes on one plane may be used. In a case where a ball array in which a sphere is located in advance at each position of all necessary nodes in one plane is used, when such a ball array is moved in the Z axis direction, the three-dimensional grid is obtained.

In the obtained data storage 7, data as shown in FIG. 4 is stored, for example. In an example of FIG. 4, for each combination of ijk, values of the measured coordinates (x, y, z) and the object coordinates (X, Y, Z) are registered.

When the coordinate data is stored in the obtained data storage 7 for all nodes in the three-dimensional grid, the control point generator 9 generates control points of a tensor-product-type composite hypersurface representing the relationship between the measured coordinates p(x, y, z) and the object coordinates P(X, Y, Z) by using the measured coordinates p(x, y, z) that are the measurement results and the object coordinates P(X, Y, Z) that are stored in the obtained data storage 7, and stores data of the generated control points into the control point data storage 13 (step S13). The “hypersurface” means a geometrical entity in an n-dimensional space that has one geometrical constraint. “Composite” means that a plurality of patches exist connectively. “Tensor product” means a multiple linear space. As for a formula expressing this, a formula obtained by increasing the dimension of a Bezier surface, a B-Spline surface, a rational B-Spline surface, a NURBS surface or the like by one dimension is used. By using the tensor-product-type composite hypersurface like this, the relationship between the measured coordinates p(x, y, z) and the object coordinates P(X, Y, Z) can be more correctly expressed. Incidentally, the tensor-product-type composite hypersurface is to interpolate the whole measurement volume including the measurement points, which results in providing approximation. However, because the tensor-product-type composite hypersurface has continuity, if the control points can be defined by more data, sufficient accuracy can be obtained.

Incidentally, the step S3 can be carried out by two methods. That is, in the first method, in the three-dimensional grid shown in FIG. 3, the measured coordinates p(x, y, z) are treated as the value of each node, and the control points are generated by sweeping the nodes in each direction of i, j and k. By adopting this method, a tensor-product-type composite hypersurface to calculate the measured coordinates p(x, y, z) from the object coordinates P(X, Y, Z) is constructed). Therefore, at the actual measurement, in order to calculate the object coordinates P(X, Y, Z) from the measured coordinates p(x, y, z) of the object to be measured, a multi-dimensional Newton method described later is necessary.

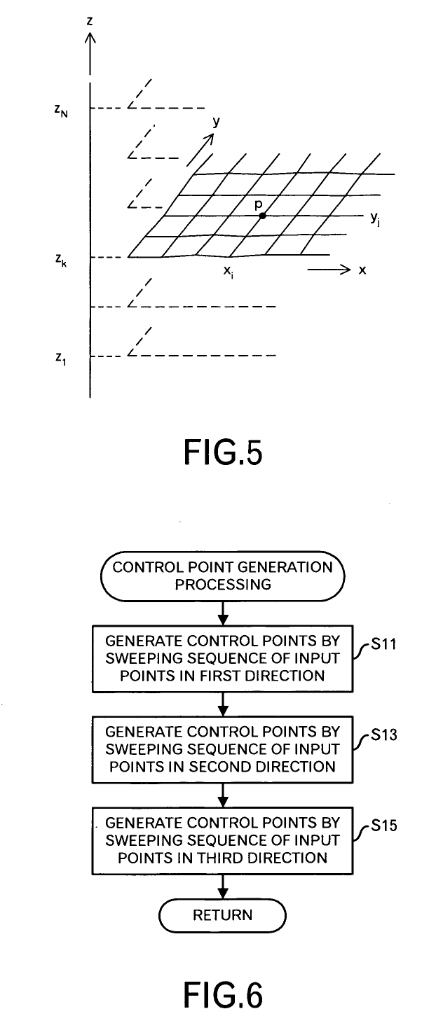

On the other hand, in the second method, the object coordinates P(X, Y, Z) are associated with the measured coordinates p(x, y, z) according to the three-dimensional grid shown in FIG. 3 at the step S1. However, at the generation of the control points, the control points are generated by sweeping the nodes in a three-dimensional grid as shown in FIG. 5 instead of the three-dimensional grid shown in FIG. 3. That is, in the three-dimensional measured coordinate system, the three-dimensional grid having L nodes in the x axis direction, M nodes in y axis direction, and N nodes in the z axis direction is used. For example, a node is indicated in a plane having a k-th coordinate value Zₖ in the z axis direction, and the coordinate values of the node p in FIG. 5 is (xᵢ, yⱼ, Zₖ). Incidentally, in the three-dimensional grid shown in FIG. 3, the node can be regularly located. However, because the positions of nodes in the three-dimensional grid shown in FIG. 5 are the measured coordinates, the three-dimensional grid has a little distortion. Although this affects the accuracy, because the object coordinates and the measured coordinates have almost the same value, the distortion is extent that can be disregarded. In the second method, in the three-dimensional grid shown in FIG. 5, the object coordinates P(X, Y, Z) are treated as the value of each node, and the control points are generated by sweeping the nodes in each direction of i, j and k. By adopting this method, a tensor-product-type composite hypersurface to calculate the object coordinate P(X, Y, Z) from the measured coordinates p(x, y, z) is constructed. Therefore, at the actual measurement, it is different from the first method in a point that the multi-dimensional Newton method is not necessary, and when the values of the measured coordinates are inputted into a formula of the tensor-product-type composite hypersurface, the actual coordinates are calculated.

First, a processing for the first method will be explained using FIG. 6. The control point generator 9 generates control points Q″ᵢⱼₖ by sweeping a node sequence (a sequence of input points) in the first direction (for example, i direction), and stores the data of the control points into the control point data storage 13 (step S11. A sequence of input points is swept, for example, in an i direction with j and k fixed to generate control points and then a sequence of input points is swept in the i direction after j or k is changed to generate control points. This processing is repeatedly performed to generate control points for all of the sequences of input points extending in the i direction. At this time, in a case where the three-dimensional Bezier curve is used, for example, the control points are calculated so as to satisfy a following equation.
p=ΣQᵢⱼₖ″Bᵢ(X)
Here, p represents a corresponding measured coordinates (x, y, z). In addition,
Bᵢⁿ(t)=ₙCᵢtⁱ(1−t)^{n-I}
is a Bernstein polynomial.

Further, the control point generator 9 sweeps a node sequence (a sequence of input points) in the second direction (for example, j direction) to generate control points Q′ᵢⱼₖ and stores data of the control points into the control point data storage 13 (step S13). Also in this case, a sequence of input points are swept, for example, in a j direction with i and k fixed to generate control points and then a sequence of input points are swept in the j direction after i or k is changed to generate control points. This processing is repeatedly performed to generate control points for all of the sequence of input points extending in the j direction. Here, the control points already generated at the step S11 is used as inputs points to generate the control points. Specifically, the control points are calculated so as to satisfy a following equation:
Qᵢⱼₖ″=ΣQᵢⱼₖ″Bⱼ(Y)

Then, the control point generator 9 sweeps a node sequence (a sequence of input points) in the third direction (for example, k direction) to generate control points Qᵢⱼₖ and stores data of the control points in the control point data storage 13 (step S15). A sequence of input points are swept, for example, in a k direction with i and j fixed to generate control points and then a sequence of input points are swept in the k direction after i or j is changed to generate control points. This processing is repeatedly performed to generate control points for all of the sequence of input points extending in the k direction. Also in this case, the control points already generated at the steps S11 and S13 are used as input points to generate control points. Specifically, the control points are calculated so as to satisfy a following equation:
Qᵢⱼₖ′=QᵢⱼₖBₖ(Z)

The finally calculated tensor-product-type composite hypersurface is represented as follows:
p=ΣQᵢⱼₖBᵢ(X)Bⱼ(Y)Bₖ(Z) (1)

Next, a processing for the second method will be explained using the same FIG. 6. The control point generator 9 sweeps a node sequence (a sequence of input points) in the first direction (for example, i direction) to generate control points q″ᵢⱼₖ and stores data of the control points in the control point data storage 13 (step S11). A sequence of input points is swept, for example, in an i direction with j and k fixed to generate control points and then a sequence of input points is swept in the i direction after j or k is changed to generate control points. This processing is repeatedly performed to generate control points for all of the sequences of input points extending in the i direction. At this time, in a case where the three-dimensional Bezier curve is used, for example, the control points are calculated so as to satisfy a following equation:
P=Σqᵢⱼₖ″Bᵢ(x)

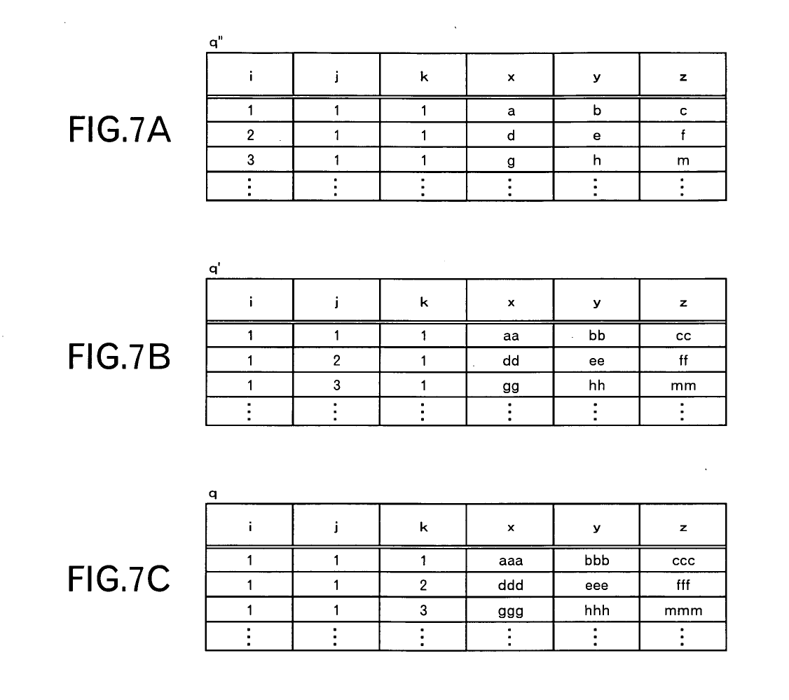

Incidentally, for example, data as shown in FIG. 7A is stored in the control point data storage 13. That is, for each combination of ijk, values (x, y, z) of the control point q″ᵢⱼₖ are stored.

Further, the control point generator 9 sweeps a node sequence (a sequence of input points) in the second direction (for example, j direction) to generate control points q′ᵢⱼₖ and stores data of the control points into the control point data storage 13 (step S13). Also in this case, a sequence of input points are swept, for example, in a j direction with i and k fixed to generate control points and then a sequence of input points are swept in the j direction after i or k is changed to generate control points. This processing is repeatedly performed to generate control points for all of the sequence of input points extending in the j direction. Here, the control points already generated at the step S11 are used as inputs points to generate control points. Specifically, the control points are calculated so as to satisfy a following equation:
qᵢⱼₖ″=Σqᵢⱼₖ ′Bⱼ(y)

Incidentally, data as shown in FIG. 7B is stored into the control point data storage 13, for example. That is, for each combination of ijk, values (x, y, z) of the control point q′ᵢⱼₖ are stored.

Then, the control point generator 9 sweeps a node sequence (a sequence of input points) in the third direction (for example, k direction) to generate control points qᵢⱼₖ and stores data of the control points into the control point data storage 13 (step S15). A sequence of input points are swept, for example, in a k direction with i and j fixed to generate control points and then a sequence of input points are swept in the k direction after i or j is changed to generate control points. This processing is repeatedly performed to generate control points for all of the sequence of input points extending in the k direction. Also in this case, the control points already generated at the steps S11 and S13 are used as input points to generate control points. Specifically, the control points are calculated so as to satisfy a following equation:
qᵢⱼₖ′=qᵢⱼₖBₖ(z)

Incidentally, data as shown in FIG. 7C is stored into the control point storage 13. That is, for each combination of ijk, values (x, y, z) of the control point qᵢⱼₖ are stored.

The finally calculated tensor-product-type composite hypersurface is represented as follows:
P=ΣqᵢⱼₖBᵢ(x)Bⱼ(y) Bₖ(z) (2)

As described above, when the control points are generated and data of the control points is held, it is possible to calculate actual coordinates (X, Y, Z) corresponding to the measured coordinates (x, y, z) at the measurement.

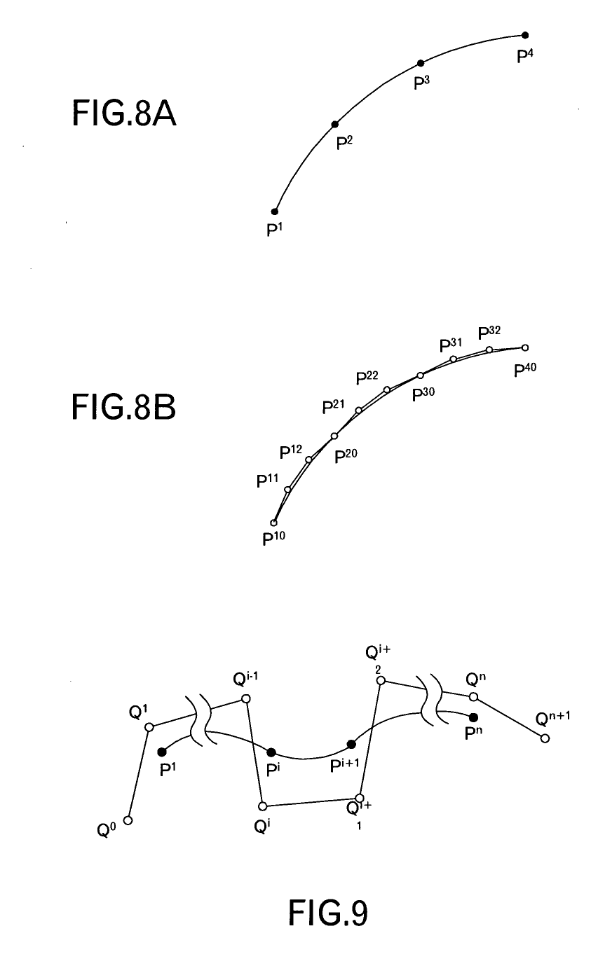

Now, a general method of generating the control points from the input points will be simply described. A case of using a comparatively simple three-dimensional Bezier curve will be described. FIG. 8A shows an example of a sequence of input points. It is assumed that a sequence of input points p¹, p², p³, and p⁴ exist. In this case, two neighboring input points (for example, p¹ and p²) are selected and their tangent vectors (for example, m¹ and m²) are determined. Then, intermediate control points (p¹¹ and p¹²) are determined as follows. Incidentally, for further detailed information, see “Curves and Surfaces for Cagd: A Practical Guide” (Morgan Kaufmann Series in Computer Graphics and Geometric Modeling), by Gerald E Farin, Morgan Kaufmann Pub; ISBN: 1558607374.
Qᵢⱼₖ′=ΣQᵢⱼₖBₖ(Z)

If this processing is repeatedly performed, a sequence of control points shown in FIG. 8B can be obtained. Incidentally, in the Bezier curve, a sequence of input points p¹, p², p³, and p⁴ are also control points. Hence, in order to differentiate them, they are designated by p¹⁰, p²⁰, p³⁰, and p⁴⁰. That is, p¹¹ and p¹² are generated between p¹⁰ and p²⁰; p²¹ and p²² are generated between p²⁰ and p³⁰; and p³¹ and p³² are generated between p³⁰ and p⁴⁰.

By the control points determined in this manner, the Bezier hypersurface is expressed for each three-dimensional hyperpatch corresponding to a one-dimensional segment or a two-dimensional patch by the following equation:
P=ΣPᵢⱼₖBᵢ³(u)Bⱼ³(v)Bₖ³(w) i,j,k ε[0,3] (3)
Here, Pᵢⱼₖ is a control point. Thus, the equation (3) has the same shape as that of the equations (1) and (2).

Further, in this embodiment, it is also possible to use not only the Bezier curve but also a uniform B-Spline curve. A case of cubic B-Spline curve will be described with reference to FIG. 9. Here, p¹, . . . pⁱ, pⁱ⁺¹, . . . pⁿ denote a sequence of input points. On the other hand, the control points of the B-Spline curve are Q⁰, Q¹, . . . Qⁱ⁻¹, Qⁱ, Qⁱ⁺¹, Qⁱ⁺², . . . Qⁿ, Qⁿ⁺¹. In the sequence of input points P and the sequence of control points Q, points with the same superscripts correspond to each other and only Q⁰ and Qⁿ⁺¹ are additionally provided. That is, the number of control points is smaller than in the case of the Bezier curve and hence a memory capacity can be decreased when storing the data of the control points.

To generate the sequence of control points as shown in FIG. 9, as the first step, Qⁱ is set at the same value as Pⁱ for i=1 to n. Here, Q⁰ is set at the same value as Q¹. Further, Qⁿ⁺¹ is set at the same value as Qⁿ. As the second step, the following equation is calculated for i=1 to n and δᵢ+Qⁱ is set at a new Qⁱ. Q⁰ is set at the same value as Q¹. Further, Qⁿ⁺¹ is set at the same value as Qⁿ.

$${δ}_{i} = {P}^{i} - {Q}^{i} + \frac{1}{2} \{ {P}^{i} - \frac{1}{2} ( {Q}^{i - 1} + {Q}^{i + 1} ) \}$$

At the third step, it is determined whether or not max {δᵢ}>δs (fixed value) and if this condition is satisfied, the processing returns to the second step. On the other hand, if this condition is not satisfied, the processing is finished. In this manner, the sequence of control points can be calculated. For further detailed contents, see “Shape Processing Engineering (II)” by Fujio Yamaguchi, published by THE NIKKAN KOGYO SHIMBUN LTD.

By the control points determined in this manner, the B-Spline hypersurface is expressed by the following equation for each three-dimensional hyperpatch corresponding to one-dimensional segment or two-dimensional patch.

$$P = {\sum }_{i , j , k} {{Q}_{ijk}}_{∈ [ 0 , 3 ]} {X}_{i}^{3} ( u ) {X}_{j}^{3} ( v ) {X}_{k}^{3} ( w ) \\ {X}_{0}^{3} ( t ) = \frac{1}{6} {( 1 - t )}^{3} \\ {X}_{1}^{3} ( t ) = \frac{1}{2} - {t}^{3} + \frac{2}{3} \\ {X}_{2}^{3} ( t ) = - \frac{1}{2} {t}^{3} + \frac{1}{2} {t}^{2} + \frac{1}{2} t + \frac{1}{6} \\ {X}_{3}^{3} ( t ) = \frac{1}{6} {t}^{3} \qquad ( 4 )$$

Here, Qᵢⱼₖ is a control point. The equation (4) also have the same shape as that of the equations (1) and (2).

In addition to this, a non-uniform B-spline curve and further, NURBS and a rational B-spline curve can be used, and hence a model to be used is not limited to the Bezier curve and the B-spline curve.

(2) Processing at the Measurement

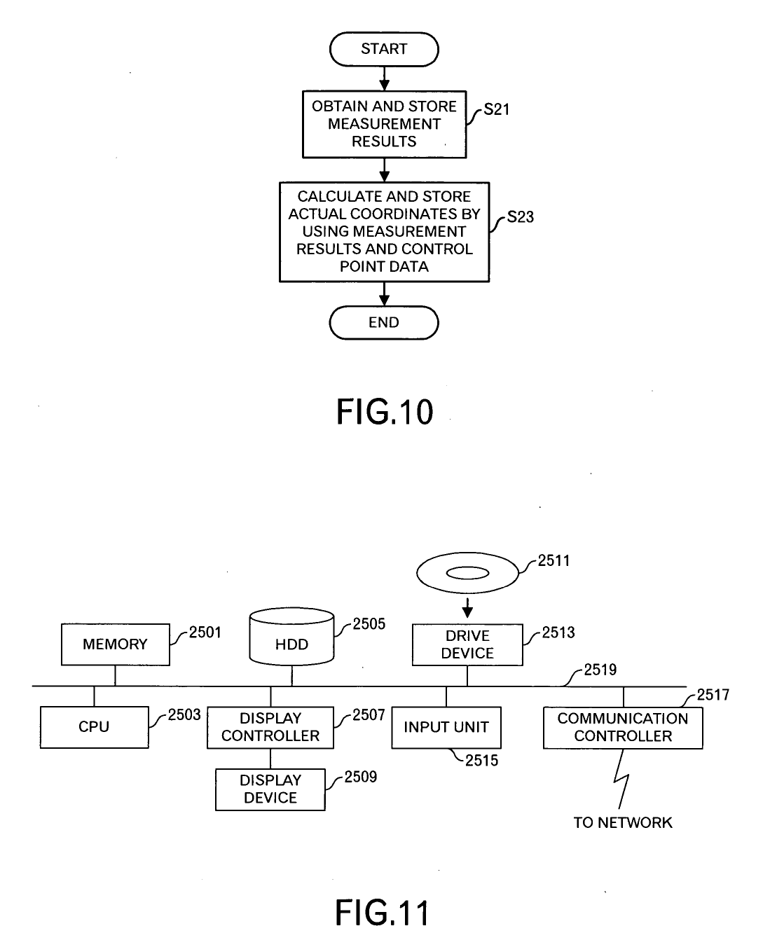

Next, a data processing at the measurement will be explained using FIG. 10. The measurement controller 5 obtains measurement results (measured coordinates (x, y, z) ) for an object to be measured from the measuring instrument 3, and stores the data into the measurement data storage 15 (step S21 in FIG. 10). The measurement coordinate sequence is output according to a predetermined rule, from the coordinates at a specific position of the object to be measured, and is stored into the measurement data storage 15.

Then, the actual coordinate calculator 17 applies the measured coordinate values stored in the measurement data storage 15 to the tensor-product-type composite hypersurface specified by the control points stored in the control point data storage 13 to calculate actual coordinates, and stores the calculated actual coordinates into the actual coordinate data storage 19 (step S23).

Incidentally, because the control points are calculated by the two methods at the calibration, two methods exist also at the step S23.

In a case where the control point Qᵢⱼₖ is calculated by the aforementioned first method, because the measured coordinates (x, y, z) cannot directly input into the equation (1), the actual coordinates are calculated by the multi-dimensional Newton method (for example, Jacobian inversion method).

The two-dimensional Jacobian inversion method is described in “Sculptured Surface Machining” by Byoung Choi et al., Kluwer Academic Publishers, 1998 and a method simply expanded to three dimensions is used here. Hereafter, the method will be briefly described. The calculation performed here is a problem to determine (X₀, Y₀, Z₀) corresponding to x*, y*, and z* that are the measurement results in a parameter expression P (X, Y, Z)=(x(X, Y, Z), y(X, Y, Z), Z(X, Y, Z)) of the tensor-product-type composite hypersurface P (the equation (1)).

As the first step, initial guess points X₀, Y₀, and Z₀ are given. Then, as the second step, δX, δY, and δZ are determined by means of three following simultaneous equations.
xₓ(X₀, Y₀, Z₀)δX+xₓ(X₀, Y₀, Z₀)δY+x_{z}(X₀, Y₀, Z₀)δZ=y*−y(X₀, Y₀, Z₀)
yₓ(X₀, Y₀, Z₀)δX+y_{Y}(X₀, Y₀, Z₀)δY+y_{z}(X₀, Y₀, Z₀)δZ=y*−y(X₀, Y₀, Z₀)
zₓ(X₀, Y₀, Z₀)δX+z_{y}(X₀, Y₀, Z₀)δY+z_{z}(X₀, Y₀, Z₀)δZ=z*−z(X₀, Y₀, Z₀)
where xₓ(X₀, Y₀, Z₀) is a partial derivative evaluated at X=X₀, Y=Y₀, Z=Z₀. This is the same as in yₓ(X₀, Y₀, Z₀) and zₓ(X₀, Y₀, Z₀) As the third step, X₀, Y₀, and Z₀ are updated in the following manner by means of δX, δY, and δZ obtained in this manner.
X₀=X₀+δX
Y₀=Y₀+δY
Z₀=Z₀+δZ

Then, as the fourth step,

(x*−x (X₀, Y₀, Z₀) )²+(y*−y (X₀, Y₀, Z₀) )²+(Z*−Z (X₀, y₀, Z₀) )² is evaluated and it is determined whether or not this is sufficiently small. In addition to this, the sum of absolute values can be used as an evaluation value. If this is sufficiently small, X=X₀, Y=Y₀, and Z=Z₀ which are obtained at the third step are solutions. On the other hand, if it cannot be said that this is sufficiently small, the processing returns to the second step.

The finally obtained X=X₀, Y=Y₀, and Z=Z₀ become the final solutions.

In a case where the control point qᵢⱼₖ is calculated by the aforementioned second method, actual coordinates can be directly calculated. This is because the equation (2) is a function of the measured coordinates (x, y, z). In this point, generating the control points qᵢⱼₖ by the second method has an advantage that the processing at the measurement can be carried out simply and at high speed. Incidentally, the conventional method method needs the multi-dimensional Newton method, and as compared to the conventional method, generating the control points by the second method has an advantage that the processing at the measurement can be carried out simply and at high speed.

As described above, according to this embodiment, the systematic error such as the distortion aberration of the optical lens can be removed.

Although one embodiment of this invention is explained, this invention is not limited to this. For example, the functional diagram shown in FIG. 1 is mere example, and program modules corresponding to the functional blocks are not always created. In addition, the measuring instrument 3 may be configured to include the measurement controller 5, the obtained data storage 7, the control point generator 9, the control point data storage 13, the measurement data storage 15, the actual coordinate calculator 17 and the actual coordinate data storage 19. Furthermore, there is a case where a computer having the measurement controller 5, the obtained data storage 7, the control point generator 9, the control point data storage 13, the measurement data storage 15, the actual coordinate calculator 17 and the actual coordinate data storage 19 is used.

In addition, such a computer is a computer device as shown in FIG. 11. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A measurement data processing method, comprising:
obtaining measured coordinate values that are measurement results for a plurality of specified positions corresponding to nodes located in a grid state in a three-dimensional space, and storing said measured coordinate values with coordinate values of said specified positions into a data storage; and
generating data of control points for a tensor-product-type composite hypersurface representing a relationship between said coordinate values of said specified positions and said measured coordinate values by using said coordinate values of said specified positions and said measured coordinate value stored in said data storage, and storing said data of said control points into a control point data storage.

2. The measurement data processing method as set forth in claim 1, further comprising calculating an actual coordinate value from a measured coordinate value of an object to be measured by using said data of said control points for said tensor-product-type composite hypersurface, which are stored in said control point data storage, and storing the calculated actual coordinate value into an actual coordinate value data storage.

3. The measurement data processing method as set forth in claim 1, wherein said generating comprises generating data of control points for a tensor-product-type composite hypersurface whose variables are said measured coordinates.

4. The measurement data processing method as set forth in claim 1, wherein said generating comprises generating data of control points for a tensor-product-type composite hypersurface whose variables are coordinates for said specific position.

5. A measurement data processing program embodied on a medium, comprising:
obtaining measured coordinate values that are measurement results for a plurality of specified positions corresponding to nodes located in a grid state in a three-dimensional space, and storing said measured coordinate values with coordinate values of said specified positions into a data storage; and
generating data of control points for a tensor-product-type composite hypersurface representing a relationship between said coordinate values of said specified positions and said measured coordinate values by using said coordinate values of said specified positions and said measured coordinate value stored in said data storage, and storing said data of said control points into a control point data storage.

6. The measurement data processing program as set forth in claim 5, further comprising calculating an actual coordinate value from a measured coordinate value of an object to be measured by using said data of said control points for said tensor-product-type composite hypersurface, which are stored in said control point data storage, and storing the calculated actual coordinate value into an actual coordinate value data storage.

7. The measurement data processing program as set forth in claim 5, wherein said generating comprises generating data of control points for a tensor-product-type composite hypersurface whose variables are said measured coordinates.

8. The measurement data processing program as set forth in claim 5, wherein said generating comprises generating data of control points for a tensor-product-type composite hypersurface whose variables are coordinates for said specific position.

9. A measurement data processing apparatus, comprising:
a unit that obtains measured coordinate values that are measurement results for a plurality of specified positions corresponding to nodes located in a grid state in a three-dimensional space, and stores said measured coordinate values with coordinate values of said specified positions into a data storage; and
a control point generator that generates data of control points for a tensor-product-type composite hypersurface representing a relationship between said coordinate values of said specified positions and said measured coordinate values by using said coordinate values of said specified positions and said measured coordinate value stored in said data storage, and stores said data of said control points into a control point data storage.

10. The measurement data processing apparatus as set forth in claim 9, further comprising a unit that calculates an actual coordinate value from a measured coordinate value of an object to be measured by using said data of said control points for said tensor-product-type composite hypersurface, which are stored in said control point data storage, and stores the calculated actual coordinate value into an actual coordinate value data storage.

11. The measurement data processing apparatus as set forth in claim 9, wherein said control point generator comprises a unit that generates data of control points for a tensor-product-type composite hypersurface whose variables are said measured coordinates.

12. The measurement data processing apparatus as set forth in claim 9, wherein said control point generator comprises a unit that generates data of control points for a tensor-product-type composite hypersurface whose variables are coordinates for said specific position.
